(19) United States
(12) Patent Application Publication
(10) Pub. No.: US 2002/0108312 A1
(43) Pub. Date: Aug. 15, 2002

(54) Reversible door having mortise hardware

(76) Inventors: Mark E. Abdella, Saint Paul, MN (US); Keith M. Kibbel, Burnsville, MN (US); John M. Parkhurst, Minnetonka, MN (US); James L. Ralph, Shoreview, MN (US); Todd N. Stratmoen, Mahtomedi, MN (US)

Correspondence Address: Michael L. Mau, Mau & Krull, P.A., Suite E, 1250 Moore Lake Drive East, Fridley, MN, 55432, US

(21) Appl. No.: 10/026,670

(22) Filed: Dec. 21, 2001

Related U.S. Application Data
(60) Provisional application No. 60/258,370, filed on Dec. 27, 2000.

(51) Int. Cl. E05D 7/02

(52) U.S. Cl. 49/382

(57) ABSTRACT

A reversible door (10), having a defined top, includes two notches (11, 12) on opposite sides of the door. A template is provided to fit into one of the notches (11 or 12) and installer drilled holes are formed through the door proximate one of the notches (11 or 12). Then, a mortised handle assembly (15) is positioned through the holes formed in the notch. A hinge assembly is secured to the opposite side of the door from the handle assembly. A snap cover (14) is positioned in the notch that does not have the handle assembly (15). Therefore, the door (10) is reversible without having to be flipped end for end and provides for a reversible door having mortised hardware.

This application claims benefit of U.S. provisional patent application Serial No. 60/258,370 filed Dec. 27, 2000.

### BACKGROUND OF THE INVENTION

1. Field of the Invention

This invention relates generally to a reversible door, and more particularly to a reversible door that can use mortise hardware.

2. Description of the Prior Art

Doors that are reversible, that is may be hinged on either side, are well known in the art. However, when using such reversible doors in which the design of the door necessitates the door be installed in a particular orientation, it has not been possible to use mortise hardware where the door is reversed by flipping the door end to end. The use of mortise hardware provides for a more aesthetically pleasing door as well as the appearance of a higher quality door. To date, this has not been possible as an effective way of doing so has not been devised.

The present invention addresses the problems associated with prior art devices and provides for the use of mortise hardware with a reversible door that cannot be flipped end to end for reversibility.

### SUMMARY OF THE INVENTION

In one embodiment, the invention is a reversible door. The door is generally rectangular having a defined top and having an inner surface and an outer surface, a first side, having a first edge, and a second side, having a second edge, the sides generally perpendicular to the surfaces. A first mortise notch is formed in the first edge of the first side and a second mortise notch is formed in the second edge of the second side. A handle assembly is adapted and configured to be secured in the other one of the mortise notches, wherein the reversible doors is able to be installed with a right hinge or a left hinge.

In another embodiment, the invention is a method of installing a reversible door with a defined top having mortised hardware. The method includes forming a first mortise notch in a first edge of a first side of the door and forming a second mortise notch in the second edge of a second side of the door. A hinge is then secured to one of the sides. Holes are formed proximate the notch of the other of the sides, the holes extending through the door. A mortise handle assembly is then secured in the notch of the other of the sides, thereby providing for a reversible door with mortised hardware assembly.

### BRIEF DESCRIPTION OF THE DRAWINGS

FIG. 1 is a front elevational view of a door according to the present invention;

FIG. 2 is a right side elevational view of the door in FIG. 1;

FIG. 3 is a left side elevational view of the door in FIG. 1;

FIG. 4 is a front elevational view showing the door in FIG. 1 with hinges on the left side;

FIG. 5 is a partial exploded perspective view of a portion in FIG. 4 showing in detail the mortise notch;

FIG. 6 is a partial exploded perspective view of the right side of the door shown in FIG. 1 and a drilling template;

FIG. 7 is a partial exploded view of a portion of the door shown in FIG. 6 with holes being drilled;

FIG. 8 is an exploded perspective view of a portion of the door show in FIG. 7 with hardware;

FIG. 9 is a front elevational view of the door shown in FIG. 1 with hinges on the right side; and

FIG. 10 is an exploded partial perspective view of a portion of the door shown in FIG. 9.

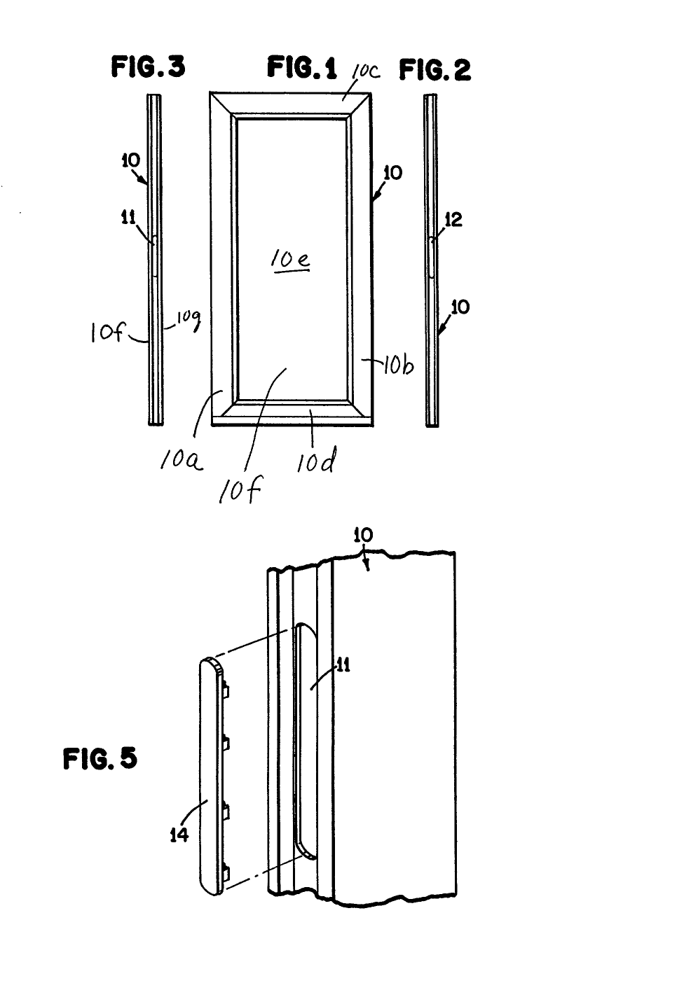

### DETAILED DESCRIPTION OF THE PREFERRED EMBODIMENT

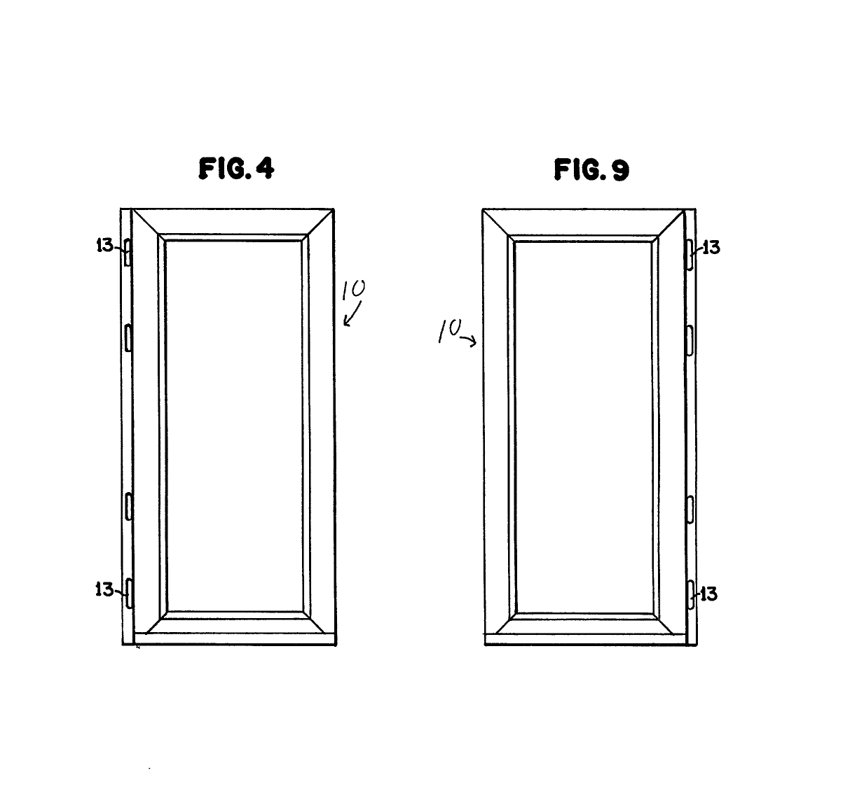

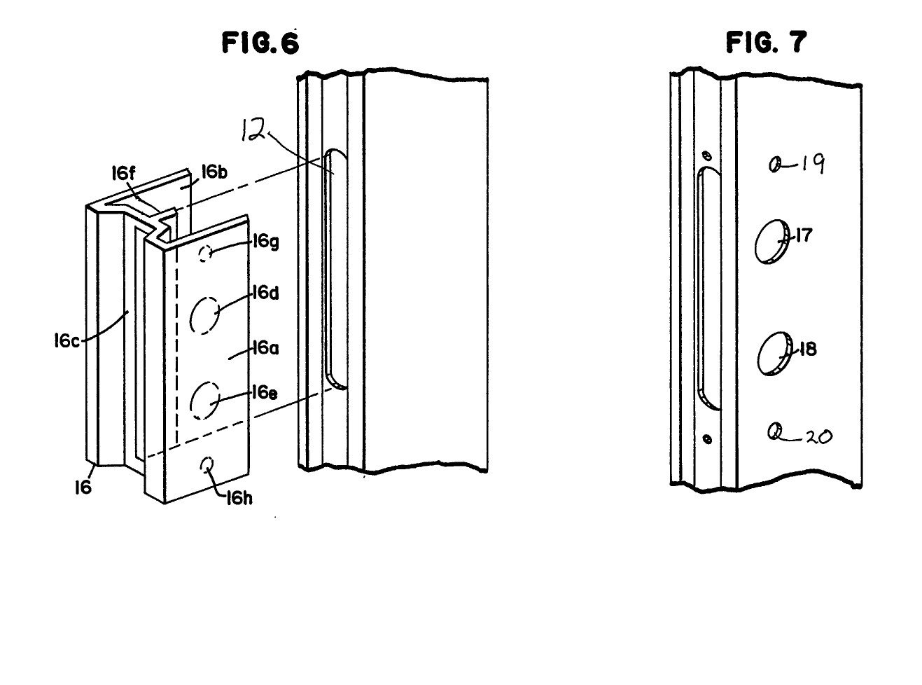

Referring to the drawings, wherein like numerals represent like parts throughout the several views, there is generally shown at 10 a door. The door 10 includes a frame having a first side 10a operatively connected to a second side 10b by a top 10c and a bottom 10d. The frame members 10a-10d are connected by means well known in the art. A panel 10e is positioned in the frame members 10a-10d. The panel 10e may be glass, a plurality of glass panes, or other suitable combinations. Further, the door 10 could be constructed from a single piece of material such as wood or other materials, either single or multiple layer construction, well known in the art. A factory-installed mortise notch 11 is formed in the left side of the door 10. A similar factory installed mortise notch 12 is formed in the right side of the door 10. The sides 10a, 10b of the frame have a width which is sufficient to allow the mortise notches 11, 12 to be formed therein. A typical size of a mortise 11, 12 is ¾″ wide ×6″ tall. The depth is sufficient to accommodate portions of the handle assembly. The mortises 11, 12 are formed in the edges of sides 10a, 10b. The panel 10e has an outer surface 10f and an inner surface 10g. The center of the mortise 11, 12 is approximately 40″ from the bottom of the door 10. The door 10 is approximately 80″ high and can be up to 96″ high. When a simple symmetric door construction exists, the mortise slot can be located on one edge, the door can be flipped end for end and the door and hardware configuration will still work. However, the present invention is used when there is not this simple symmetry related to the door construction around a horizontal axis. Such a door can be referred to as a door with a defined top as it will not function properly when flipped end for end. The use of two mortise notches at the same horizontal height overcomes this problem. Further, in FIG. 3, the surfaces are shown as having the same width as the rest of the door. It is understood that for a storm door utilizing glass, the thickness of the panel 10e would be often somewhat less than the overall thickness of the frame of the door. FIG. 4 shows hinges 13 installed on the edge of the door for a left hinge installation and FIG. 9 shows hinges 13 installed on the edge of the door for a right hinge installation. The hinges 13, well known in the art, may be secured by any suitable means, well known in the art. A snap-in mortise cover 14 is inserted into the mortise notch 11 if a left hinge installation is desired. The cover plate is sized and configured to cover the mortise notch 11, 12 and may be secured by any suitable method such as a snap fit as shown in the figures. Alternately, a plate could be secured, by suitable means such as screws, over the mortise notch to cover the opening. The mortise cover plate 14 is inserted into the mortise notch 12 if a right hinge installation is desired. The mortise cover plate 14 is installed on the left side 10a if a left hinge installation is desired. For the right hinge installation, the hinge 13 is secured to the right side 10b. Alternately, for a left side installation, the hinge 13 would be secured to the left side 10a, it being seen that the mortise cover plate is attached to the same side as the hinge. A mortised handle assembly, generally designated at 15, is secured through the mortise notch 12 for a left hinge installation and through the mortise notch 11 for a right hinge installation. Only the installation into the mortise notch 12 will be described in detail as it is similar for installation into the mortise notch 11. Referring to FIG. 6, a hole positioning template 16 has a right side 16a operatively connected to a left side 16b by a side section 16c. Formed in the right side 16a are two drill hole templates 16d, 16e. Similar drill hole templates are formed in the left side 16b and are in axial alignment with the hole template 16d, 16e. The hole-positioning template 16 fits around the side of the door and is positioned properly vertically by a mortise locator member 16f. The mortise-locating member 16f is substantially the same size as the mortise notch 11 and provides for holding the template 16 in position in the mortise notch 11. There is therefore no need to measure to locate the template a certain height as the member 16f properly located the template for subsequent drilling.

Referring to FIG. 7, the installer will then drill holes through the drill hole templates 16d, 16e to provide for clearance holes 17, 18 formed in the door 10. The holes 17, 18 extend through the width of the door 10. Similarly, the template 16 has two additional drill hole templates 16g, 16h. The consumer also drills holes through the drill hole templates 16g, 16h to provide for holes 19, 20 for securing the handle assembly 15 with screws 21. The holes 17-20 are formed proximate the notch and are generally perpendicular to the notch.

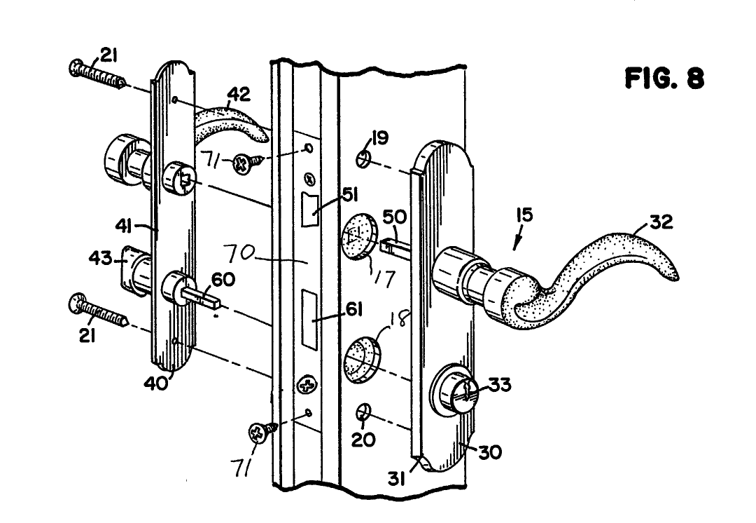

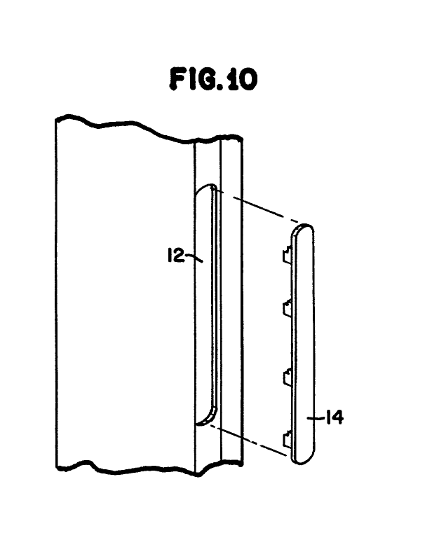

Referring to FIG. 8, the handle assembly 15 includes an exterior handle assembly 30 and an interior trim plate assembly 40. A suitable handle assembly is available from Wright Products, Rice Lake, Wisconsin. The exterior handle assembly 30 includes a plate 31 and a rotatable handle 32 operatively connected to the plate 31. A lock 33 is operatively connected to the plate 31. The handle 32 is sized and configured to be positioned in alignment with hole 17 and the lock 33 is sized and configured to be positioned in alignment with hole 18. The interior trim plate assembly 40 includes a plate 41 having a rotatable handle 42 operatively connected thereto and a rotatable lock knob 43 is also operatively connected to the plate 41. The handle 42 is sized and configured to align with hole 17 and the rotatable lock knob is sized and configured to align with hole 18. The handles 32, 42 are connected by a spindle 50. A livebolt 51 is operatively connected to the rod 50 for latching and unlatching the door 10. The lock 33 and rotatable lock knob 43 are connected by a spindle 60. The spindle 60 is operatively connected to a deadbolt 61 to lock the door 10 into a frame (not shown). The live bolt 51 and deadbolt 61 extend through a plate 70. The plate 70 is secured to the edge of the side 10a by screws 71.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A reversible door, comprising:
a) a generally rectangular door having a defined top and having an inner surface and an outer surface, a first side having a first edge and a second side having a second edge, the edges generally perpendicular to the surfaces;
b) a first mortise notch formed in the first edge of the first side and a second mortise notch formed in the second edge of the second side; and
c) a handle assembly adapted and configured to be secured in one of the mortise notches, wherein the reversible door is able to be installed with a right hinge or a left hinge.

2. The door of claim 1, further comprising a cover plate adapted and configured to be secured over the other one of the mortise notches.

3. The door of claim 2 wherein the cover plate is sized and configured to have a snap fit within the other one of the mortise notches.

4. A method of installing a reversible door having a defined top having mortised hardware, comprising:
a) forming a first mortise notch in a first edge of a first side of a door;
b) forming a second mortise notch in a second edge of a second side of the door;
c) securing a hinge to one of the sides;
d) forming holes proximate the notch of the other of the sides, the holes extending through the door; and
e) securing a mortised handle assembly in the notch of the other of the sides, thereby providing for a reversible door with mortised handle assembly.

5. The method of claim 4, further comprising securing a cover plate to the notch of the one of the sides.

6. The method of claim 4, further comprising, providing a template for use in forming the holes, the template held in position by the template fitting in the notch of the one of the sides.
